(19) United States
(12) Patent Application Publication
(10) Pub. No.: US 2017/0190154 A1
(43) Pub. Date: Jul. 6, 2017

(54) ULTRAVIOLET AND INFRARED ABSORBING POLYMERIC FILMS AND LAMINATES

(71) Applicant: CN Innovations Limited, Hong Kong (CN)

(72) Inventors: Shaqi GE, Hong Kong (CN); Ka Wai WONG, Hong Kong (CN); Ka Ming NG, Hong Kong (CN)

(21) Appl. No.: 14/987,991

(22) Filed: Jan. 5, 2016

(51) Int. Cl. B32B 17/10

(52) U.S. Cl. CPC B32B 17/10678; B32B 17/10761; B32B 2264/10; B32B 2307/412

(57) ABSTRACT

A ultraviolet and infrared absorbing polyvinyl butyral film is disclosed which is comprised of copper chalcogenide nanoparticles and oxide nanoparticles. The polyvinyl butyral film has a visible transmittance greater than 75%, at least 50% absorption between 780 and 1400 nm, around 100% absorption beyond 1400 nm, and at least 85% absorption in the UV region. Also disclosed is a laminate comprising one or more substrates, a polymeric matrix disposed on or between the one or more substrates, and copper chalcogenide nanoparticles dispersed in the polymeric matrix. The laminate has a visible transmittance greater than 75%, at least 50% absorption between 780 and 1400 nm, around 100% absorption beyond 1400 nm, and at least 85% absorption in the UV region

### FIELD

The present subject matter relates to an ultraviolet (UV) and infrared (IR) absorbing polyvinyl butyral (PVB) film, a sheet made therefrom, and glass laminates containing the film as an interlayer. More particularly, the present subject matter relates to a PVB film comprising copper chalcogenides, copper sulfide (CuS) in particular, and more particularly a PVB film comprising both copper chalcogenides and metal oxides.

### BACKGROUND

The solar radiation spectrum is divided into different radiation regions defined by the wavelength range. For example, the UV region refers to the 100-380 nm range of solar radiation; the visible region refers to the range of 380-780 nm; and the near IR region refers to the range of 780-2500 nm.

Each radiation region of the solar spectrum can impose different effects on the environment, as well direct effects on humans. Although small amounts of UV light can be beneficial for humans, prolonged exposure to UV radiation can damage human skin and lead to acute and chronic health issues. Similarly, prolonged exposure to UV light can also damage or tarnish goods such as furniture. Prolonged exposure to near IR radiation can heat up an object; while radiation in the visible region of the spectrum provides natural lighting. As such, solar radiation not only brings natural lighting to a building or an automobile interior through windows, it also brings along unwanted effects from UV and near IR radiation. The former causes direct harm and damage to objects in the interior of a space; while the latter raises the interior temperature, and thus large amounts of electricity are consumed by air-conditioners to maintain a comfortable interior temperature in warm and hot weather. As such, a functional window that transmits visible light but blocks UV and near IR light is essential for buildings and automobiles to reduce the electricity load and to protect all objects and users inside.

Commonly, glazin0gs for windows are used to create more insulation, making a structure more energy efficient by reducing heat loss through the windows. However, glazings, including laminated glazings, tend to transmit heat energy, thus can be particularly problematic in confined spaces, such as a car. Heat shielding glazings for windows may comprise multiple thin silver layers and antireflective layers deposited on glass to block the sun's damaging rays, or reduce outside noise. However, the visible transmittance is usually low and the metallic layers have corrosion issues. The technique of using multiple thin silver layers and antireflective layers is also limited because the film thickness of the metal must be very thin to ensure transparency. Also, the corresponding deposition machines for manufacturing these windows are very expensive.

Alternatively, laminated glass windows with polymeric interlayers are commonly employed for safety concerns and improved energy efficiency, with polyvinyl butyral (PVB) resin sheets being the most common glass laminate. PVB sheets are commonly used because they can hold sharp glass fragments in place when the glass is broken. Thus, PVB laminated safety glass is widely applied in architecture and automobile glazings, show cases, and other places where human interactions are highly involved. With its already existing popularity, it will be even more beneficial if IR and UV absorbing materials can be combined with PVB laminates to achieve a multifunctional glass which blocks IR and UV, and is safe when broken. Further, the integration of inorganic nanoparticles into a polymer matrix of a PVB laminate is an efficient way to couple the properties of the inorganic phase with that of the transparent polymer to enhance the overall mechanical, physical, and chemical properties. This leads to new polymer-based functional materials that have wide application in various industrial fields.

It has been demonstrated that certain nanoparticles can be dispersed in a polymer matrix, e.g. PVB, and absorb near IR or UV light while transmitting a high level of visible light. For example, zinc oxide nanoparticles absorb UV light; antimony tin oxide (ATO) and lanthanum hexaboride (LaB₆) nanoparticles absorb near IR light with absorption peaks around 1400 nm and 1000 nm respectively. U.S. Pat. No. 5,518,810 discloses that coatings containing ITO particles can block IR light beyond 1000 nm while retaining a high transmittance in the visible region. U.S. Pat. No. 6,911,254 describes laminates comprising a PVB matrix, LaB₆ and ITO powders, to block near IR light starting from 800 nm with a 70% transmittance in the visible region.

Further, copper deficient copper chalcogenide nanocrystals have shown to be absorptive near the IR region. Copper chalcogenide nanocrystals are p-type semiconductor materials. Their free carriers arise from the free electron holes in the valence band generated because of copper vacancies, which results in absorbance near the IR range based on the localized surface plasmon resonance (LSPR) effect. The absorption peak lies between 900 nm to 1200 nm, depending on the extent of the copper deficiency, which is complementary to the absorption peaks of doped metal oxides at around 1400 nm. Currently, copper chalcogenides are generally applied in photothermal therapy and bio-imaging. They are also promising materials for supercapacitors and solar cells. However, there is no disclosure or suggestion of developing and employing copper chalcogenide nanoparticles as IR or UV absorptive dispersions in a PVB matrix, particularly for use in high-performance safety glass laminates.

### SUMMARY

Accordingly, the present subject matter provides a polyvinyl butyral (PVB) film which absorbs light within the IR and UV regions of the radiation spectrum, with greater than 75% transmittance in the visible region. In one embodiment, the PVB film comprises at least an IR absorbing amount of copper chalcogenide nanoparticles dispersed in a polyvinyl butyral resin. Preferably, the copper chalcogenide is copper sulfide, although other copper chalcogenide nanoparticles are contemplated. The copper chalcogenide nanoparticles are in a range between 3 to 30 nm and are present in an amount between 0.01 to 5 wt %, and more particularly 0.1 to 1 wt %, of the PVB film. The polyvinyl butyral film has at least 50% absorption between 780 and 1400 nm and around 100% absorption beyond 1400 nm, and has at least 85% absorption in the UV region.

In another embodiment of the present subject matter, a laminate is provided. The laminate absorbs light within the near IR and UV regions of the radiation spectrum. The laminate comprises one or more substrates and a polymeric matrix disposed on or between the one or more substrates. The polymeric matrix includes at least an IR absorbing amount of copper chalcogenide nanoparticles dispersed in the thermoplastic polymeric matrix. Other copper chalcogenides can be applied in the present subject matter, but copper sulfide is preferred. The copper chalcogenide nanoparticles are in a range between 3 to 30 nm and are present in an amount between 0.01 to 5 wt %, and more particularly 0.1 to 1 wt %, of the polymeric matrix. Many thermoplastic polymeric materials may be used as the polymeric matrix, such as ethylene-vinyl acetate (EVA), thermoset EVA, and thermoplastic polyurethane (TPU), yet the preferred thermoplastic polymer is PVB. The substrates of the laminate are typically visually transparent single or multilayered rigid sheets such as clear or tinted glass sheets.

The PVB film or laminate may include other light absorbing components in combination with the copper chalcogenide nanoparticles dispersed in the polymer matrix, such as oxide nanoparticles. The oxide nanoparticles, such as ITO, ATO, or mixtures thereof, are dispersed in the PVB film or polymeric matrix with the copper chalcogenide nanoparticles. The oxide nanoparticles are present in an amount between 0.1 to 10 wt %, or more particularly, 0.5 to 3 percent by weight of the PVB film or polymeric matrix. Further, these additional components may also be dispersed in separate polymer sheets for a multilayer laminate.

Additional light reflective layers such as multi-layered silver/antireflective coatings and multi-layered polymer films can also be combined with the copper chalcogenide added PVB laminate by coating or attaching the reflective layers to any one side of the glass substrate, or to the PVB film.

### BRIEF DESCRIPTION OF THE DRAWINGS

Although the characteristic features of the present subject matter will be particularly pointed out in the claims, the subject matter itself and manner in which it may be made and used may be better understood after a review of the following description, taken in connection with the accompanying drawings wherein like numeral annotations are provided throughout.

FIGS. 1A and 1B show two laminate structures according to embodiments of the present subject matter.

FIG. 2 shows a light transmission spectrum (380 nm to 2500 nm) of PVB films with 0.1 wt. % and 0.3 wt. % CuS nanoparticles compared with a pure PVB films.

FIG. 3 shows a light transmission spectrum (380 nm to 2500 nm) of PVB films with 1.5 wt. % ITO nanoparticles and 0.1 wt. % or 0 wt. % CuS nanoparticles compared with pure PVB films.

FIG. 4 shows a light transmission spectrum (200 nm to 380 nm) of PVB films with 0.1 wt. % and 0.3 wt. % CuS nanoparticles compared with pure PVB films.

FIG. 5 shows a light transmission spectrum (200 nm to 380 nm) of PVB films with 1.5 wt. % ITO nanoparticles and 0.1 wt. % or 0 wt. % CuS nanoparticles compared with pure PVB films.

FIG. 6 shows a light transmission spectrum (200 nm to 380 nm) of PVB films with 1.5 wt. % ITO nanoparticles, 1.5 wt. % ITO and 0.2 wt. % LaB₆ nanoparticles, 0.1 wt. % CuS nanoparticles, and 1.5 wt. % ITO and 0.1 wt. % CuS nanoparticles compared with pure PVB films.

FIG. 7 shows a light transmission spectrum (380 nm to 2500 nm) of PVB films with 1.5 wt. % ITO nanoparticles, 1.5 wt. % ITO and 0.2 wt. % LaB₆ nanoparticles, and 1.5 wt. % ITO and 0.1 wt. % CuS nanoparticles, compared with pure PVB films.

FIG. 8 is the X-ray powder diffraction (XRD) pattern of the product from Example 2.

FIG. 9 is the transmission electron microscopy (TEM) image of the product from Example 2.

FIG. 10 is the XRD pattern of the product from Example 3.

FIG. 11 is the TEM image of the product from Example 3.

FIG. 12 is the UV-Vis spectra of different IZO dispersions at different concentrations of IZO nanocrystals in hexane (weight percentage) from Example 3.

FIG. 13 is the UV-Vis spectra of different IZO/PVB nanocomposite with different IZO loadings from Example 3.

### DETAILED DESCRIPTION

Reference is made herein to the attached drawings Like reference numerals are used throughout the drawings to depict like or similar elements of the present subject matter. The figures are intended for representative purposes only and should not be considered to be limiting in any respect.

“Laminate” as used herein refers to structures having one or more substrates with interlayers interposed between substrates or attached to a substrate.

The present subject matter is directed to an ultraviolet and infrared absorbing PVB film and laminates that comprise copper chalcogenides. The present subject matter employs copper chalcogenide nanoparticles as IR and UV absorptive dispersions in a polymeric matrix, particularly for use in high-performance safety glass laminates. Copper chalcogenides dispersed in a polymer matrix, e.g. PVB, exhibit improved absorption near IR and UV light while transmitting a high level of visible light.

Copper chalcogenides, such as CuS, CuSe, and CuTe, are effective IR absorbers with an absorption peak around 1100 nm, which is complementary to other doped metal oxide IR absorbers such as ITO and ATO. Both ITO and ATO can be dispersed in a polymer matrix, e.g. PVB, and absorb near IR or UV light while transmitting a high level of visible light. Thus, CuS can be used in conjunction with ITO and ATO so as to adjust the range of light to be absorbed. The amount of CuS in the polymeric matrix is generally in the range between 0.01 wt. % to 4 wt. %, particularly about 0.1 wt. % to 0.4 wt. %. The amount of ITO or ATO in the polymeric matrix is generally in the range between 0.05 wt. % to 5 wt. % of the polymeric matrix, particularly about 0.5 wt. % to 2 wt. %.

The nanoparticles dispersed in the polymeric matrix must be a particular size, including those with surface functional groups or ligands, and with dopants. Particularly, the nanoparticles dispersed in the polymeric matrix have diameters less than 500 nm and preferably in a range of 5 nm to 30 nm.

The nanoparticles can be surface modified using different surface functionalization and engineering techniques, to facilitate homogeneous dispersion in a polymeric matrix. For example, when the CuS nanoparticle is coated with oleic acid and oleylamine, the absorption peak red shifts compared with the one coated with pure oleylamine. The nanoparticles can also be doped by different material engineering techniques, to manipulate their optical characteristic.

According to one embodiment of the present subject matter, CuS nanoparticles are synthesized via wet chemistry. Typically, CuCl and sulfur powder are dissolved in oleylamine (OAm) at 120° C. in an inert atmosphere to form Cu-OAm and S-OAm precursors. Then the S-OAm precursor is injected into the Cu-OAm precursor. The reaction is allowed to proceed for 1 to 5 minutes. The product is then washed with ethanol, dried, and dispersed in organic solvents. It is also contemplated that other common nanoparticle synthesizing methods are also applicable, which include, but are not limited to, mechanical milling, laser ablation, pyrolysis, combustion, precipitation, lithography, and sol gel methods.

Any polymeric material conventionally used in laminates may be used as the polymeric matrix of the present subject matter. PVB is by far the most widely used safety glass laminate material, and thus, is a contemplated polymeric matrix material. PVB is used to produce films that are noted for optical clarity and physical toughness and also adheres well to a variety of surfaces. These attributes make PVB films useful in many optical applications including laminated safety glass for automotive windshields, architectural glasses, and bulletproof glass panes. Other polymeric matrix materials include, but are not limited to, ethylene-vinyl acetate (EVA), thermoset EVA, and thermoplastic polyurethane (TPU). Further, the polymeric matrix used in the present subject matter can also be loaded with plasticizer for acoustic damping and other material characteristics.

Each of the nanoparticles preferably introduced into the PVB matrix by first dissolving the PVB into a solvent and adding the suspension comprising dispersed nanoparticles in the same solvent. Solvents include, but is not limited to, methyl alcohol, N, N-dimethylformamide, isopropyl alcohol, methylene chloride, chloroform, n-butyl alcohol, cyclohexane, diacetone alcohol, N, N-dimethylacetamide, dimethylsulfoxide, ethyl acetate, ethyl alcohol, isophorone, N-methyl-2-pyrrolidone, propylene dichloride, tetrachloroethylene, and tetrahydrofuran.

In another example embodiment, the PCB matrix further includes monodispersed indium doped zinc oxide (IZO) nanocrystals. The IZO nanocrystals may be synthesized by the pyrolysis of organo-indium-zinc precursors. In some embodiments, the precursors can be indium-zinc stearate, indium-zinc laurate, indium-zinc myristate, indium-zinc palmitate, indium-zinc caprate etc. which include the long alkyl tail and the metal ions. With different reaction conditions, IZO particles with an average size ranged from 10-300 nm can be obtained. The IZO nanocrystals can be dispersed in a non-polar solvent, such as such as chloroform or toluene, forming an optically transparent solution. Homogeneous nanocomposite solutions are obtained by dispersing the IZO and the polymer (PVB and PMMA) into the same solvent.

In another example embodiment, the IZO nanocrystals are synthesized by reacting indium and zinc metal separately with a fatty acid at about 270° C. to form organo-indium and organo-zinc precursors. The fatty acids used in the reaction should have aliphatic tails longer than 10 carbon atoms such as stearic acid, lauric acid, and capric acid. According to one method, the first route is direct pyrolysis where IZO particles are synthesized by decomposing the mixture of organo-indium and organo-zinc precursors at a temperature above their decomposition points, according to the experimental data, the temperature should be higher than 320° C. According to another method, the second route is alcohol-assisted pyrolysis, where IZO nanoparticles are synthesized by injecting the long alkyl chain alcohol to a mixture of organo-indium and organo-zinc precursors at the specified temperature and the temperature should not below 250° C.

IZO nanopaticles with flowery shapes and an average size of 100-300 nm can be synthesized by direct pyrolysis, while IZO nanopaticles with an average size of 10-30 nm can be synthesized by alcohol-assisted pyrolysis.

In a scaled up manufacturing process, the PVB film can be prepared by mixing the resin, the plasticizers, and the nanoparticles, and subsequently extruding the mixed formulation through a sheet die. The plasticizers added include, but are not limited to, triethylene glycol bis(2-ethylbutyrate), triethylene glycol di-(2-ethylhexanoate), triethylene glycol diheptanoate, tetraethylene glycol diheptanoate, dihexyl adipate, dioctyl adipate, hexylcyclohexyladipate, mixtures of heptyl and nonyl adipates, diisononyl adipate, heptylnonyl adipate, dibutyl sebacate, and oil-modified sebacic alkyds.

In another embodiment of the present subject matter, the PVB film and laminate include a solar control function and a noise control function. A separate high plasticizer loaded PVB layer is attached to the solar control PVB layer via lamination process. Due to the lower viscosity, the high plasticizer layer can absorb a large portion of sound waves. Also, large amount of plasticizer can be added to the aforementioned nanoparticle integrated PVB films, adding noise control function to the PVB film. The addition of plasticizer or the attachment of an additional high plasticizer loaded PVB layer does not decrease the transmission in the visible region or the UV/IR absorption.

As a free-standing PVB film for various applications, the abovementioned PVB film and laminate can be combined with reflective layers, forming an integrated laminate layer. These reflective layer can comprise of one or multiple antireflective layers (e.g. silver), or one or multiple polymer layers with a designated thicknesses, or a combination thereof.

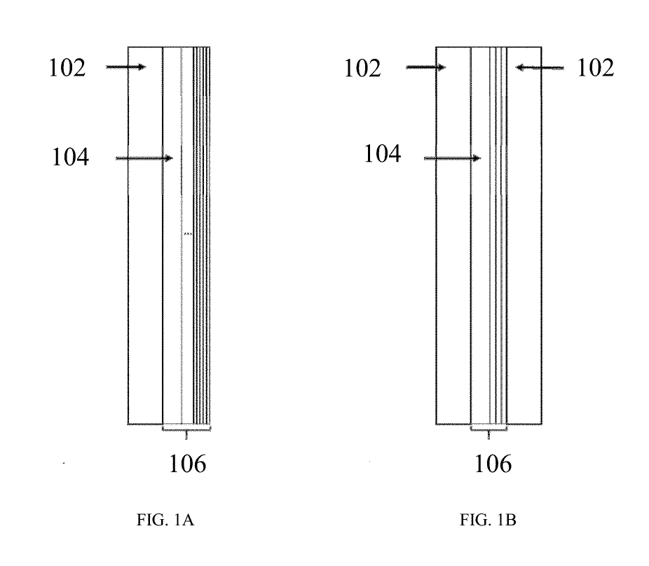

Referring now to FIGS. 1A and 1B, there are shown two laminate structures according to embodiments of the present subject matter. As shown in FIG. 1A, the abovementioned free-standing PVB film 104 or integrated laminate layer 106 can be coupled to one or more substrates 102. The combination of the PVB film 104 and one or more reflective layers 108 comprise the integrated laminate layer 106. Similarly, FIG. 1B shows the integrated laminate layer 106, including the PVB film 104, sandwiched between two substrates 102. These substrates 102 include, but are not limited to, glass, plastic, or any multilayered structure with or without vacuum or material filled enclosure.

Lamination of the PVB film to glass substrates can be achieved based on generally known industrial techniques. Preferably, the PVB film is placed between two glass substrates, and then placed into a rubber bag and evacuated. Heat and pressure are applied to the rubber bag until the PVB film is firmly attached to the two substrates on each side of the PVB film. The substrates include, but are not limited to, glass, polyester (PE), and polyethylene terephthalate (PET).

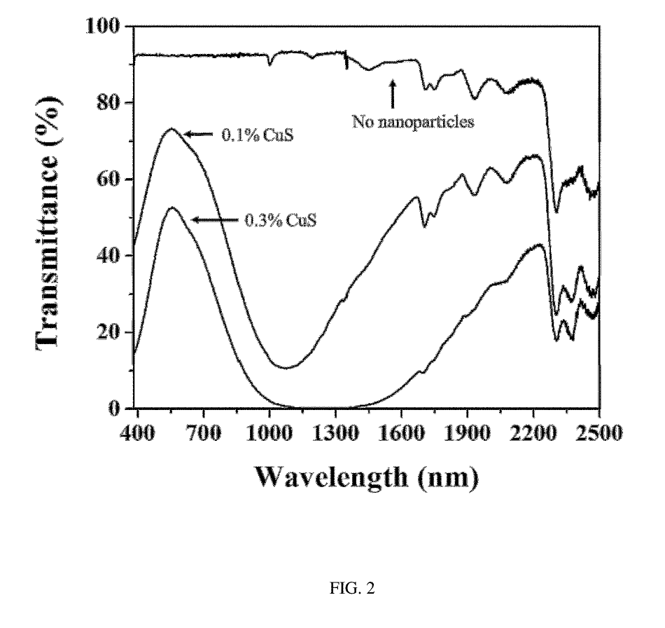

According to one embodiment of the present subject matter, FIG. 2 shows the IR absorbing effect of copper chalcogenide nanoparticles, specifically CuS nanoparticles. Compared with pure PVB film absent nanoparticle loading, 0.1 wt. % CuS loaded PVB film shows a transmittance in the visible region at around 75%, and a notable decrease of the near IR transmittance with a large extent down to around 10% at 1000 nm. The PVB film loaded with 0.3 wt. % of CuS blocked 100% of near IR within the range of around 1000 nm to 1400 nm, but sacrificed the visible transmittance to around 52%.

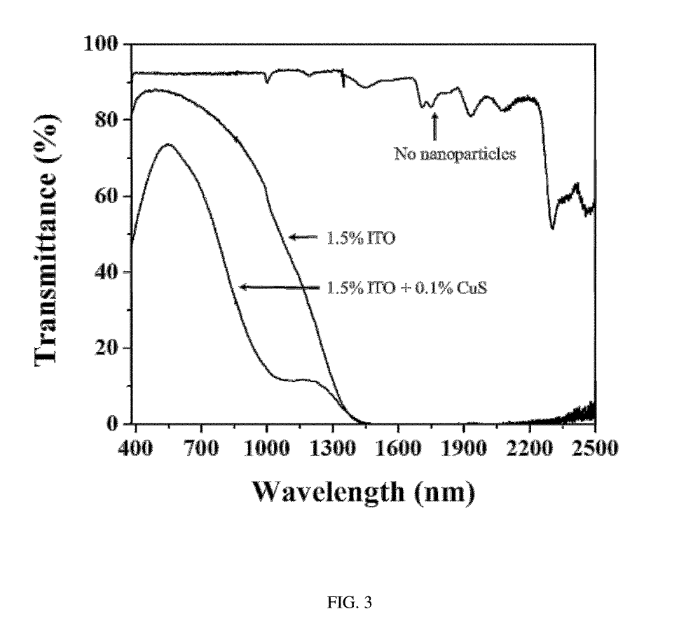

According to another embodiment of the present subject matter, FIG. 3 shows the IR blocking performance of the PVB films loaded with both ITO and CuS nanoparticles. Compared with pure PVB film absent nanoparticle loading, 1.5 wt. % ITO nanoparticle loaded PVB film blocked almost all the near IR beyond 1400 nm with a slight drop of visible transmittance. When 0.1 wt. % of CuS was added to the 1.5 wt. % ITO loaded PVB film, the absorption of IR radiation between 780 nm to 1200 nm was more significant with only around a 12% drop in the visible transmittance.

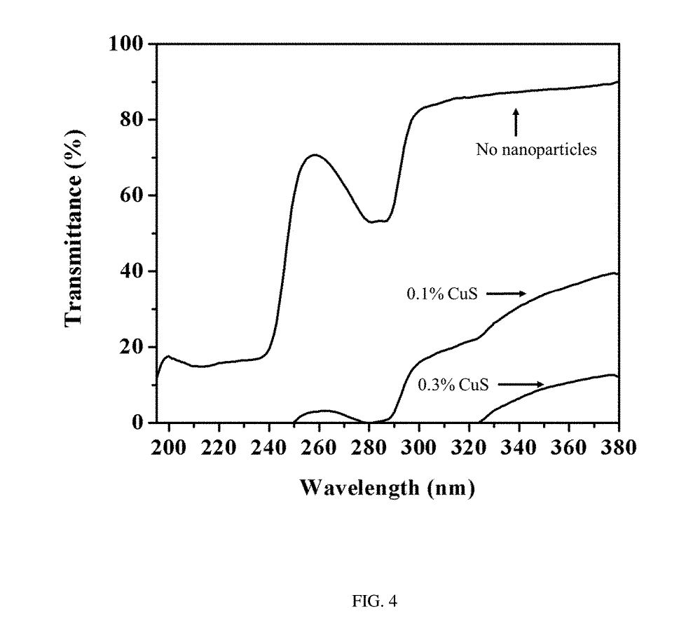

As shown in FIG. 4, CuS nanoparticles loaded PVB films can also absorb UV radiation. The transmittance of UV radiation at 380 nm drops from around 90% for pure PVB film to 40% for 0.1 wt. % CuS loaded PVB film and to 10% for 0.3 wt. % CuS loaded PVB film. At around 285 nm, the UV transmittance decreased to almost 0% in both 0.1 and 0.3 wt. % CuS loaded PVB films while it is still around 52% for pure PVB film.

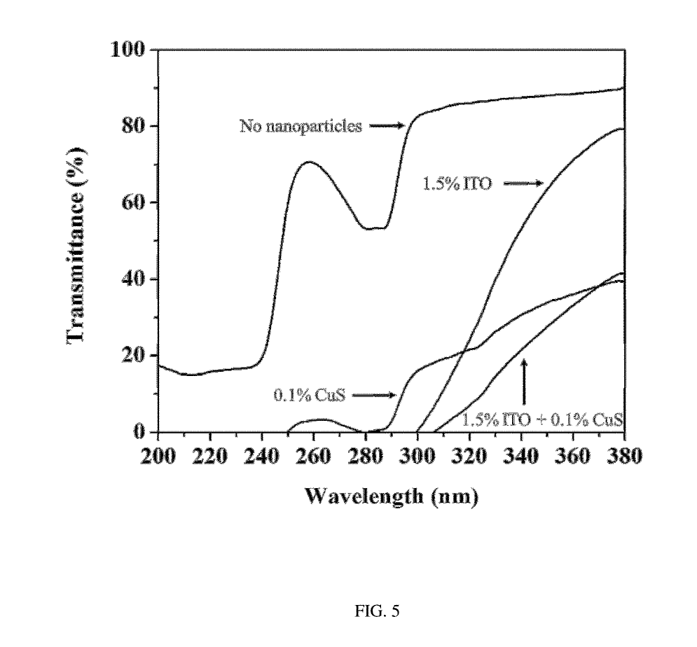

The UV blocking effect is also evident in ITO and CuS loaded PVB film, as illustrated in FIG. 5. The UV radiation at less than 300 nm is completely blocked in both ITO loaded PVB film and the combination of ITO and CuS loaded PVB films. The UV radiation within 380 nm is also blocked to around 80% transmittance for 1.5 wt. % ITO loaded PVB film and around 42% transmittance for 1.5 wt. % ITO and 0.1 wt. % CuS loaded PVB film.

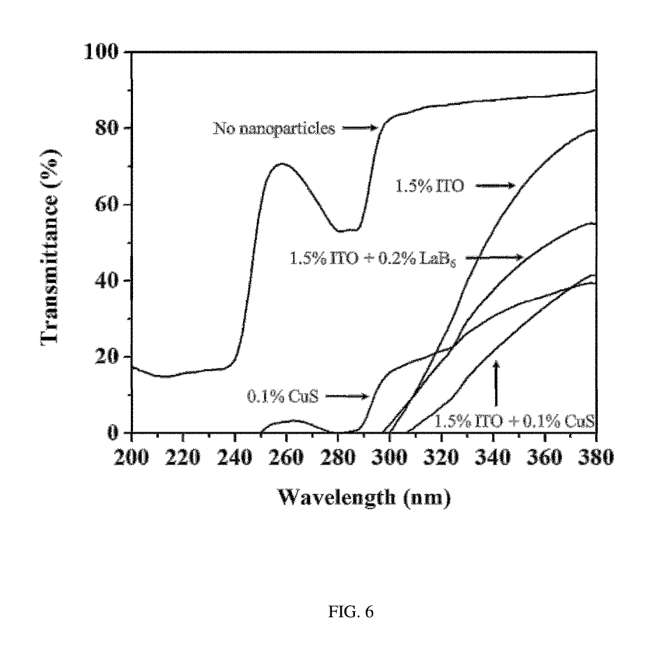

Further, a comparison was made with PVB laminates with LaB₆ nanoparticles, as the latter is known as one of the effective near IR absorbers already commercialized. FIG. 6 shows the UV transmittance from 200-380 nm of a PVB film with 1.5 wt. % ITO nanoparticles, 1.5 wt. % ITO and 0.2 wt. % LaB₆ nanoparticles, a PVB film with 0.1 wt. % CuS nanoparticles, and 1.5 wt. % ITO and 0.1 wt. % CuS nanoparticles and pure PVB films. Evidently, the PVB film with 1.5 wt. % ITO and 0.1 wt. % CuS nanoparticles shows an even higher UV absorption than that with ITO and LaB₆ nanoparticles.

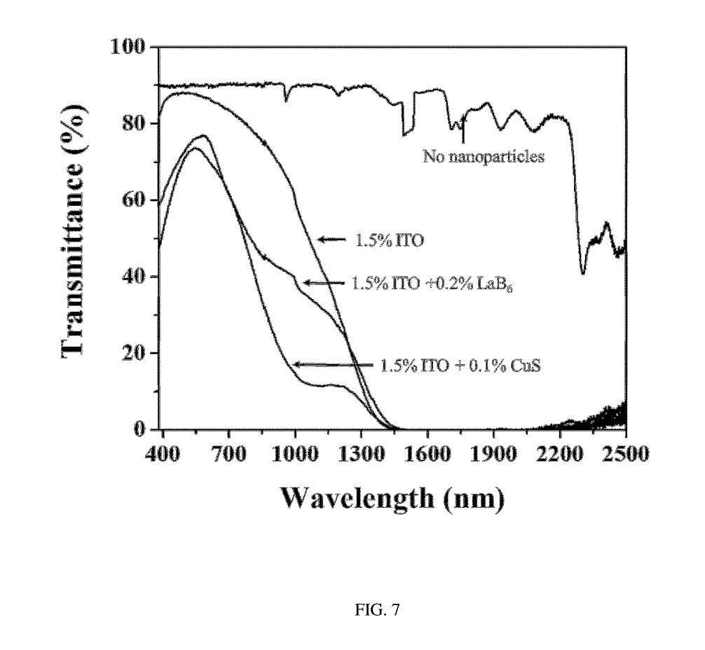

FIG. 7 shows the light transmittance within 380-2500 nm of a PVB film with 1.5 wt. % ITO nanoparticles, 1.5 wt. % ITO and 0.2 wt. % LaB₆ nanoparticles, a PVB film with 1.5 wt. % ITO and 0.1 wt. % CuS nanoparticles, and a pure PVB film. Again, the PVB film with 1.5 wt. % ITO and 0.1 wt. % CuS nanoparticles excels in absorbing light within the near IR region around 1000 nm compared to the other PVB films, exhibiting the enhanced UV and IR absorption of PVB films with copper chalcogenide nanoparticles.

### Fabrication of IZO/polymer Nanocomposite:

A certain amount of IZO solution and polymer (such as PVB and PMMA) were dissolved in a non-polar solvent (such as chloroform and toluene) to form a clear composite solution. The dispersion was homogeneous with the IZO nanocrystals distributing in the polymer matrix. The IZO/PVB nanocomposite film was fabricated by pouring the dispersion in a mold and evaporating the non-polar solvent. The IZO loading in the polymer matrix and the properties of the final product (such as thickness and shape) can be controlled easily.

### EXAMPLE 1

0.65 g zinc metal and 6.29 g stearic acid were added to a reactor and the reactor was heated at 270° C. for 5 hours to obtain the zinc stearate precursor. 0.115 g indium metal and 0.851 g stearic acid were added into the reactor and heated at 260° C. for 3 hours to obtain the indium stearate. The indium-zinc stearate compound was obtained by mixing these two precursors at 150° C.

### EXAMPLE 2

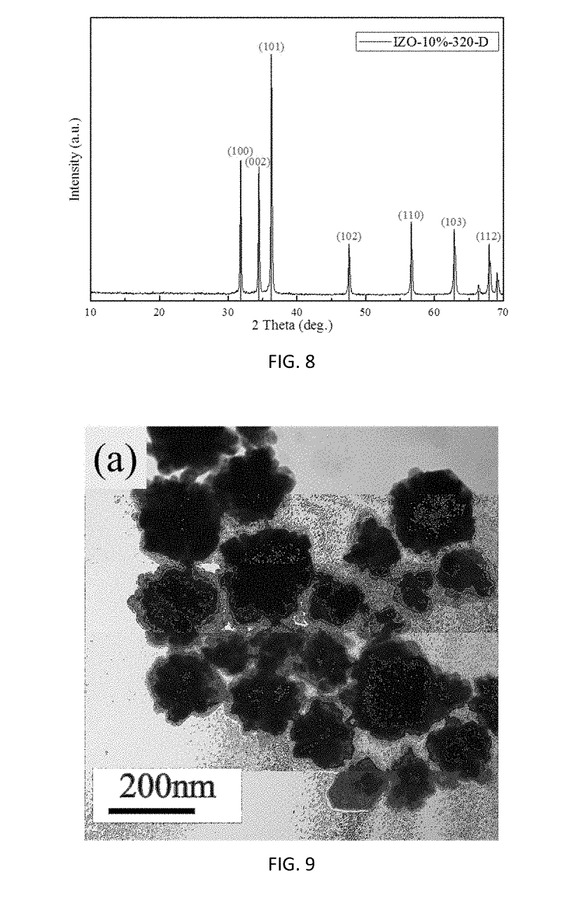

The mixture of example 1 was heated from room temperature to 320° C. with a heating rate of 10° C./min and was held at 320° C. for 5 hours for the pyrolysis reaction under a nitrogen atmosphere. After 5 hours, the flask was cooled down to 150° C. for 2 hours and a green precipitate was observed at the bottom of the flask. Then, the precipitate was washed by hot ethanol to remove by-products, and dried at 80° C. overnight under vacuum. Finally, the IZO particles in powder form were obtained. The XRD pattern of the light green powder is displayed in FIG. 8, which matches well with the main diffraction peaks of hexagonal wurtzite zinc oxide (JCPDS file No.36-1451), and no other crystalline phase was detected. The result indicated that the indium ions inserted into the zinc oxide lattice and formed indium doped zinc oxide. The sharp peaks of the XRD pattern illustrated that the particle size was large. The morphologies and particle size of the IZO samples were examined by TEM, as shown in FIG. 9. The particle size was about 200 nm.

### EXAMPLE 3

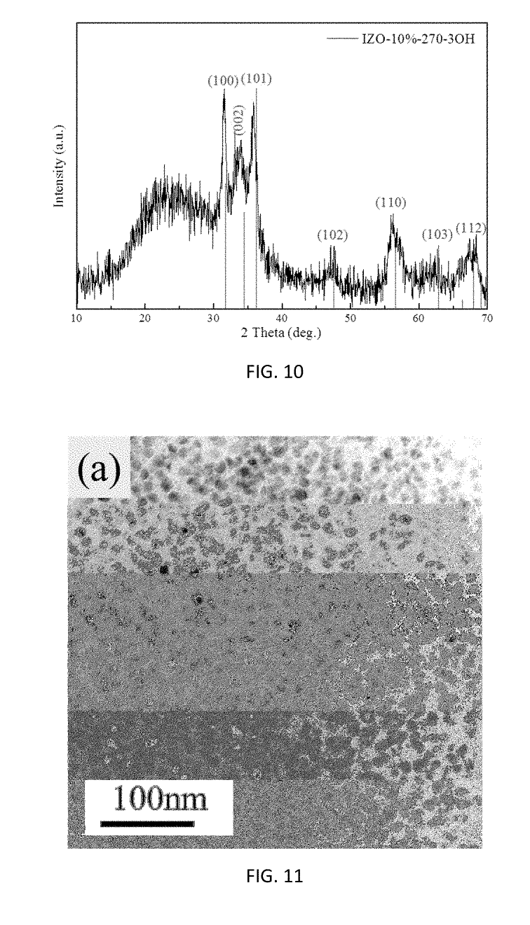

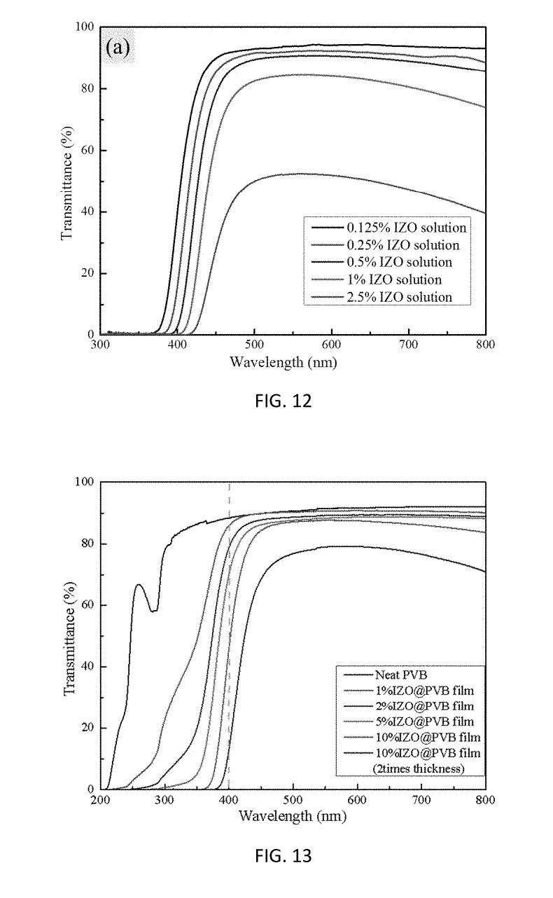

The indium-zinc stearate precursor (example 1) was heated from room temperature to 270° C. with a heating rate of 10° C./min. When the temperature reached 270° C., 20 mL oleic alcohol (85%, Sigma-Aldrich) was quickly injected into the flask. The pyrolysis reaction was kept at 270° C. for 3 hours under a nitrogen atmosphere. After 3 hours, the flask was cooled down and a green mixture was observed. Then, the precipitate was washed by hot ethanol to remove by-products, and dried at 80° C. overnight. Finally, IZO nanoparticles in powder form were obtained. The XRD pattern is displayed in FIG. 10. The broad peaks centered at the peak positions matched quite well with the main diffraction peaks of the hexagonal wurtzite zinc oxide, and no peaks of discernable indium oxide or other zinc oxide compounds were detected. Therefore, the IZO nanocrystals consisted of a solid solution of the indium zinc oxide. The monodispersed IZO nanocrystals were successfully synthesized, without any agglomeration (FIG. 11). The sample was ˜10 nm in size and could be dispersed in the non-polar solvent such as hexane, toluene or chloroform to form an optically clear solution. The UV-Vis spectra of different IZO dispersions at different concentrations of IZO nanocrystals in hexane (weight percentage) from example 3 and UV-Vis spectra of different IZO/PVB nanocomposite with different IZO loadings from example 3 are shown in FIGS. 12 and 13, respectively.

We claim:

1. A laminate transparent to visible light and absorptive near IR and UV light, comprising:
one or more substrates;
a polymeric matrix disposed on or between the one or more substrates;
copper chalcogenide nanoparticles dispersed in the polymeric matrix;
wherein the laminate has a visible transmittance greater than 75%;
wherein the laminate has at least 50% absorption between 780 and 1400 nm and around 100% absorption beyond 1400 nm; and
wherein the laminate has at least 85% absorption in the UV region.

2. The laminate of claim 1, further comprises oxide nanoparticles dispersed in the polymeric matrix.

3. The laminate of claim 2, wherein the oxide nanoparticles are selected from a group consisting of indium tin oxide, antimony tin oxide, and mixtures thereof.

4. The laminate of claim 2, wherein the oxide nanoparticle is indium doped zinc oxide nanoparticles.

5. The laminate of claim 4, wherein the indium doped zinc oxide particles have an average size between 100 to 300 nm.

6. The laminate of claim 1, further comprises a reflective film attached or coated to one side of the one or more substrates, wherein the reflective film has a predetermined thickness.

7. The laminate of claim 6, wherein the reflective film comprises one or more layers selected from a group consisting of silver, antireflective coatings, and combinations thereof.

8. The laminate of claim 1, wherein the polymeric matrix comprises a polyvinyl butyral.

9. The laminate of claim 1, wherein the copper chalcogenide nanoparticles are CuS nanoparticles.

10. The laminate of claim 1, wherein the one or more substrates are selected from a group consisting of a clear glass sheet, a tinted glass sheet and a multilayered glass sheet.

11. The laminate of claim 1, wherein the copper chalcogenide nanoparticles are less than 500 nm.

12. The laminate of claim 1, wherein the copper chalcogenide nanoparticles are in a range between 3 to 30 nm.

13. The laminate of claim 1, wherein the copper chalcogenide nanoparticles are present in an amount between 0.01 to 5 percent by weight of the polymeric matrix.

14. The laminate of claim 1, wherein the copper chalcogenide nanoparticles are present in an amount between 0.1 to 1 percent by weight of the polymeric matrix.

15. The laminate of claim 2, wherein the oxide nanoparticles are less than 500 nm.

16. The laminate of claim 2, wherein the oxide nanoparticles are in a range of 10 to 30 nm.

17. The laminate of claim 2, wherein the oxide nanoparticles are present in an amount between 0.1 to 10 percent by weight of the laminate.

18. The laminate of claim 2, wherein the oxide nanoparticles are present in an amount between 0.5 to 3 percent by weight of the laminate.

19. The laminate of claim 1, wherein a thickness of the polymeric matrix is in a range between 0.5 mm to 10 mm.

20. The laminate of claim 1, wherein a thickness of the polymeric matrix is in a range between 2 mm to 4 mm.

21. A polyvinyl butyral film transparent to visible light comprising a polyvinyl butyral resin absorptive near IR and UV light, comprising:
copper chalcogenide nanoparticles;
wherein the polyvinyl butyral film has a visible transmittance greater than 75%;
wherein the polyvinyl butyral film has at least 50% absorption between 780 and 1400 nm and around 100% absorption beyond 1400 nm; and
wherein the polyvinyl butyral film has at least 85% absorption in the UV region.

22. The polyvinyl butyral film of claim 21, further comprises oxide nanoparticles dispersed in the polyvinyl butyral resin.

23. The polyvinyl butyral film of claim 22, wherein the oxide nanoparticles are selected from a group consisting of indium tin oxide, antimony tin oxide, and mixtures thereof.

24. The polyvinyl butyral film of claim 22, wherein the oxide nanoparticle is indium doped zinc oxide nanoparticles.

25. The polyvinyl butyral film of claim 24, wherein the indium doped zinc oxide particles have an average size between 100 to 300 nm.

26. The polyvinyl butyral film of claim 21, further comprises a reflective film attached or coated to one side of the polyvinyl butyral film, wherein the reflective film has a predetermined thickness.

27. The polyvinyl butyral film of claim 26, wherein the reflective film comprises one or more layers selected from a group consisting of silver, antireflective coatings, and combinations thereof.

28. The polyvinyl butyral film of claim 21, wherein the copper chalcogenide nanoparticles are CuS nanoparticles.

29. The polyvinyl butyral film of claim 21, wherein the copper chalcogenide nanoparticles are less than 500 nm.

30. The polyvinyl butyral film of claim 21, wherein the copper chalcogenide nanoparticles are in a range of 3 to 30 nm.

31. The polyvinyl butyral film of claim 21, wherein the copper chalcogenide nanoparticles are present in an amount between 0.01 to 5 percent by weight of the polyvinyl butyral resin.

32. The polyvinyl butyral film of claim 21, wherein the copper chalcogenide nanoparticles are present in an amount between 0.1 to 1 percent by weight of the polyvinyl butyral resin.

33. The polyvinyl butyral film of claim 22, wherein the oxide nanoparticles are less than 500 nm.

34. The polyvinyl butyral film of claim 22, wherein the oxide nanoparticles are in a range of 10 to 30 nm.

35. The polyvinyl butyral film of claim 22, wherein the oxide nanoparticles are present in an amount between 0.1 to 10 percent by weight of the polyvinyl butyral resin.

36. The polyvinyl butyral film of claim 22, wherein the oxide nanoparticles are present in an amount between 0.5 to 3 percent by weight of the polyvinyl butyral resin.

37. The polyvinyl butyral film of claim 21, wherein a thickness of the polyvinyl butyral film is in a range between 0.5 mm to 10 mm.

38. The polyvinyl butyral film of claim 21, wherein a thickness of the polyvinyl butyral film is in a range between 2 mm to 4 mm.
